(19) United States
(12) Patent Application Publication
(10) Pub. No.: US 2004/0220855 A1
(43) Pub. Date: Nov. 4, 2004

(54) Advertising management method and system using egg labelling

(76) Inventors: Steve Carignan, Montreal (CA); Luc Trottier, Repentigny (CA)

Correspondence Address: TESTA, HURWITZ & THIBEAULT, LLP, HIGH STREET TOWER, 125 HIGH STREET, BOSTON, MA, 02110, US

(21) Appl. No.: 10/744,129

(22) Filed: Dec. 23, 2003

Related U.S. Application Data
(63) Continuation-in-part of application No. 09/915,449, filed on Jul. 27, 2001, now abandoned.

(30) Foreign Application Priority Data
Jul. 28, 2000 (CA) 2,315,267
Jan. 27, 2003 (CA) 2,417,052

(51) Int. Cl. G06F 17/60; B44C 1/00

(52) U.S. Cl. 705/14; 705/1; 156/541

(57) ABSTRACT

In an advertising management method and system using eggs as advertising media to communicate at least one information/message from an advertiser to a number of consumers, the at least one information/message to be communicated is obtained from the advertiser. Also obtained from the advertiser are parameters related to at least one targeted destination toward which eggs conveying the at least one information/message have to be directed, a ratio of the number of information/message conveying eggs with respect to the total number of eggs directed toward the at least one targeted destination, a total number of information/message conveying eggs, and a time frame during which the information/message conveying eggs have to be distributed. The information/message is applied during the time frame to shells of the eggs directed toward the targeted destination in accordance with the above-mentioned ratio until the total number of information/message conveying eggs has been reached.

### CROSS-REFERENCE TO RELATED APPLICATIONS

The instant application is a continuation-in-part of United States patent application serial no. 09/915,449 filed Jul. 27, 2001, which claims priority to Canadian patent application serial no. 2,315,267 filed Jul. 28, 2000. The instant application also claims priority to and the benefits of Canadian patent application serial no. 2,417,052 filed Jan. 27, 2003. The entire disclosures of the '449, '267, and '052 patent applications are herein incorporated by reference in their entireties.

### FIELD OF THE INVENTION

The present invention relates to an advertising management method and system wherein, in particular but not exclusively, eggs are used as an advertising vehicle or media.

In the following description and the appended claims, the term “information/message” in intended to designate any “information” and/or “message” to be communicated to consumers through eggs used as an advertising vehicle or media.

### BACKGROUND OF THE INVENTION

New advertising vehicles are continuously developed in an attempt to find more efficient tools to attract consumers'attention and communicate information. Food products are bought, manipulated and used on a daily basis by every family. Therefore, they constitute a powerful tool for communicating information. Packages are often used to carry miscellaneous printed information and communicate this information to the different members of families; an example is the information about missing people printed on milk containers. Some bulk food products such as fruits and vegetables are also carrying small labels of information, which are usually related to the product itself or its producer. Eggs are manipulated in every household almost if not every day and their generally white or pale shells constitute a powerful advertising media or vehicle.

However, applying good quality advertising information on eggs represents a technical challenge.

Ink jet printers are currently used to apply written information such as the packing date or lot number on eggshells. Such a system is described for example in U.S. Pat. No. 4,843,958 granted to Egosi in 1989. To avoid egg contamination vegetable based inks must be used, which vegetable based inks are available in a very limited selection of pale colors. Moreover, the egg shape and its high relative speed with respect to the printer yield distortion in droplet distribution and poor definition. Attractive advertising requires a high-definition multi-color process and thus cannot be applied by direct printing with existing technologies.

Therefore, application of pre-printed labels on eggshells has been considered; Japanese publication No. JP10101048 by Nanbu in 1998 describes such a process. This publication describes a labelling system for the printing and application of labels bearing information such as the packing date on the eggshells contained in the cavities of packages carried by belt conveyers.

The labelling system of Nanbu is not sufficiently fast to selectively label eggshells while the eggs travel at high speed on the chain conveyer, as would be required to label eggshells as a function of the destination (packing machine) of the eggs. At a given point in time, eggs supplied to a given packing machine are shipped to a specific distributor, retailer or other client and each egg is directed to a specific packing machine in relation to its characteristics and size. Obviously, for advertising purposes, not every client should receive labelled eggs. For example, retailers such as grocery stores should be provided with labelled eggs while commercial suppliers and industrial users should not.

The above described prior art also fails to describe an advertising management method and system using eggshells as an advertising media or vehicle. This will allow an advertiser to communicate information to a group of consumers through an advertising service provider.

### SUMMARY OF THE INVENTION

The present invention relates to an advertising management method using eggs as advertising media to communicate at least one information/message from an advertiser to a number of consumers, comprising:

obtaining the at least one information/message to be communicated from the advertiser;

obtaining from the advertiser parameters related to at least one targeted destination toward which eggs conveying the at least one information/message have to be directed, and a ratio of the number of information/message conveying eggs with respect to the total number of eggs directed toward the at least one targeted destination; and

applying the at least one information/message to shells of the eggs directed toward the at least one targeted destination in accordance with the above-mentioned ratio.

The present invention also relates to an advertising management system using eggs as advertising media to communicate at least one information/message from an advertiser to a number of consumers, comprising:

an advertising service provider for obtaining from the advertiser:

the at least one information/message to be communicated to the number of consumers;

parameters related to at least one targeted destination toward which eggs conveying the at least one information/message have to be directed, and a ratio of the number of information/message conveying eggs with respect to the total number of eggs directed toward the at least one targeted destination;

an information/message applying device applying the at least one information/message to be communicated to shells of the eggs directed toward the targeted destination in accordance with the said ratio.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a side elevation view of a non-restrictive illustrative embodiment of an in-line egg-labelling system showing a label-applying device installed beneath the chain conveyer of an egg sorting and packing system for applying labels to the underside of the eggs carried in grippers of the chain conveyer;

FIG. 2 is a block diagram showing components of the non-restrictive illustrative embodiment of in-line egg-labelling system, in cooperation with elements of an existing egg sorting and packing system;

FIG. 3a is a front elevation view of a non-limitative example of advertising media;

FIG. 3b is an exploded view of the advertising media of FIG. 3a, showing a multi-layer structure of a printed pressure sensitive adhesive label;

FIG. 4a is a front elevation view of a non-limitative alternative example of advertising media;

FIG. 4b is an exploded view of the advertising media of FIG. 4a, showing a multi-layer structure of a printed multi-colour indicia;

FIG. 5 is a block diagram of a non-restrictive illustrative embodiment of advertising management system according to the present invention; and

FIG. 6 is a block diagram of a non-restrictive illustrative embodiment of advertising management method according to the present invention.

### DETAILED DESCRIPTION OF THE ILLUSTRATIVE EMBODIMENTS

A non-restrictive illustrative embodiment of an in-line egg-labelling method and system according to the present invention will now be described in connection with the appended drawings.

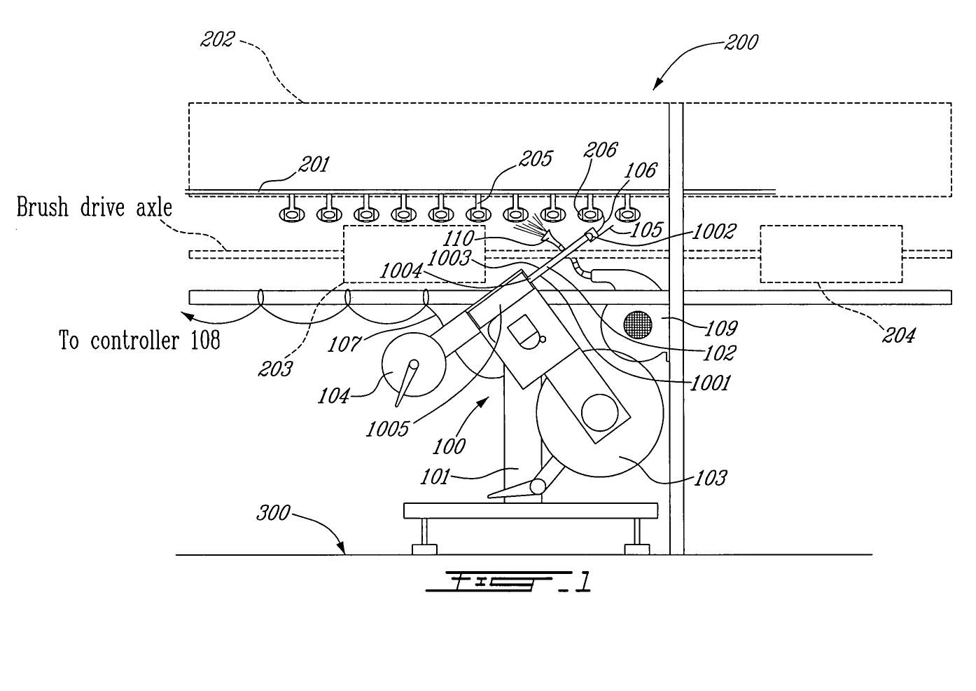

FIG. 1 illustrates a label-applying device generally identified by the reference 100. This label-applying device 100 co-operates with an egg sorting and packing system 200 partly illustrated in FIG. 1. More specifically, FIG. 1 of the appended drawings shows the portion of the egg sorting and packing system 200 extending from a second egg-packing station represented by a transfer brush 203 to a third egg-packing station represented by a transfer brush 204.

The egg sorting and packing system 200 comprises a chain conveyor 201 protected by an elongated enclosure 202. These chain conveyor 201 and elongated enclosure 202 extend through the egg sorting and packing system 200 to carry the eggs through a series of egg-processing stations including the above-mentioned second and third egg-packing stations.

As can be seen from FIG. 1, a series of egg-retaining grippers 205 project downwardly from the chain conveyer 201. As well known to those of ordinary skill in the art, each egg-retaining gripper 205 comprises two opposite, articulated concave plastic or metal spoons that can be moved toward each other to grip an egg in an horizontal position parallel to the direction of displacement of the chain conveyer 201 and subsequently spread apart from each other to release the egg.

Eggs such as 206 are carried by the series of egg-retaining grippers 205 starting from an upstream section (not shown) of the egg sorting and packing system 200 where cleaning, weighting, inspection and grading of the eggs take place. The chain conveyor 201 then processes through a first egg-processing station (not shown), the above-mentioned second egg-packing station, the above-mentioned third egg-packing station, etc. The function of the first egg-processing station is to sort and receive rejected eggs, while the function of the second and third egg-packing stations is to sort and pack eggs of different grades and/or characteristics.

Ink jet printer(s) used for printing the date and lot number on the eggs 206 to be packed downstream are located in the space between the first egg-processing station and the second egg-packing station whereby this space is not available to install a label-applying device. Therefore, the most upstream location available to install the label-applying device 100 is the space between the second and third egg-packing stations represented by the transfer brushes 203 and 204, respectively. However, this space is very limited and no existing standard label-applying device fits in this very limited space.

In the non-restrictive illustrative embodiment of the present invention, the label-applying device 100 is a stand-alone unit mounted on its own base 101 supported on the floor 300. This label-applying device 100 can be a modified version of a high-speed labelling machine such as the HERMA 300 MODULAR SYSTEM provided by the Germany based company HERMA Labelling Systems, and comprises an elongated flat arm 102 to bring a label from a feed roll 103 to a lower surface of the target egg 206.

More specifically, the labels such as 106 of the feed roll 103 are self-adhesive labels applied to a paper backing ribbon collected on roll 104 after the labels such as 106 have been peeled off and applied to the shells of eggs 206. More specifically, the paper backing ribbon from roll 103 runs upwardly on the lower face 1001 of the flat arm 102 with the self-adhesive labels 106 under the ribbon, turns on the small-diameter rounded free end 1102 of the flat arm 102, and finally runs downwardly on the upper face 1003 of the flat arm 102 to reach the roll 104. Since the free end 1002 of the flat arm 102 has a small diameter, sudden turning of the paper backing ribbon causes peeling off of the label 106 located at the free end 1002 of the flat arm 102, with the self-adhesive face of the label 106 facing upwardly. A smoothing brush, roller, pad, air jet or the like 105 mounted on the free end 1002 of the flat arm 102 spreads and sticks the label 106 to the lower face of the egg 206.

In order to fit in the space available between the second and third egg-packing stations and reach the lower face of the eggs 206:

The flat arm 102 of the label-applying device 100 has been extended and narrowed to a width smaller than the diameter of a typical egg; and

The lower end 1004 of the flat arm 102 has been mounted on an adjustable bracket 1005 providing for the required inclination of the arm 102 about the horizontal.

As the incoming eggs 206 have just been washed in water, some moisture is usually still present on the surface of the shell when an egg 206 reaches the label-applying device 100. To overcome this potential problem, water-based adhesive is used on the labels 106 and the thickness and formulation of the layer of adhesive are carefully adjusted to provide good adhesion of the labels to the surface of the eggs 206. Nevertheless, to ensure that the surface of the incoming eggs is as dry as possible, an air blower 109 with a nozzle 110 located slightly upstream of the label-applying device 100 projects air at high speed on the lower surface of the incoming eggs 206 to dry this area of the eggs both by evaporation and evacuation of water. An air-drying device such as a compact thermoelectric condensing unit can also be installed in the air path of the blower to ensure that the projected air is not saturated with moisture since the ambient air may contain a high degree of humidity. Some heating of the air flow may also be provided downstream to increase air temperature and thereby further reduce relative humidity and improve drying efficiency.

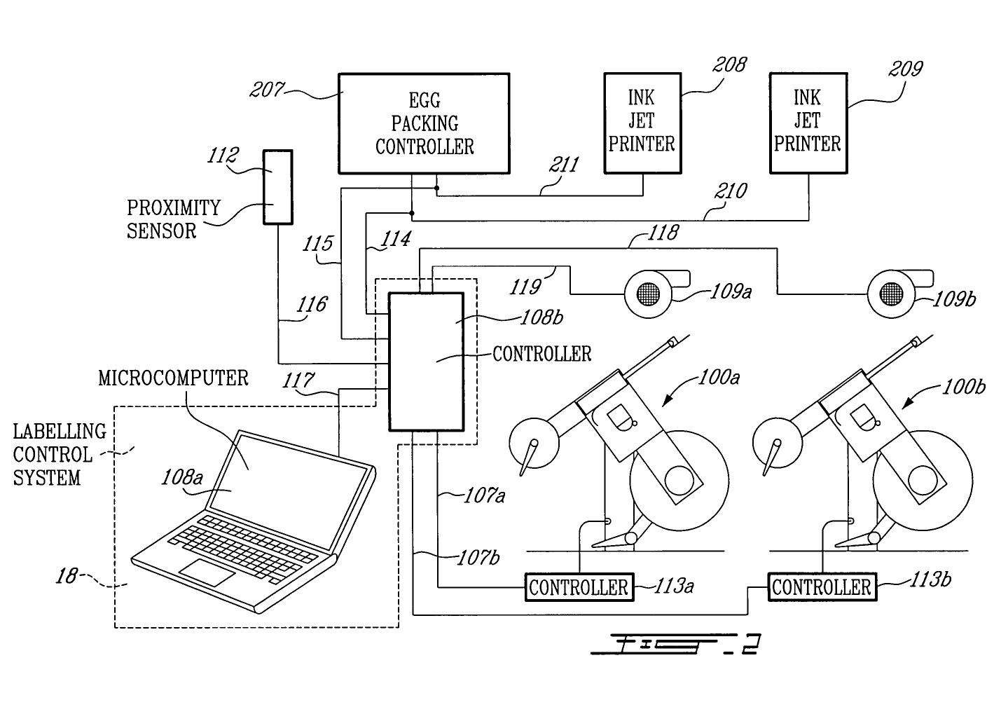

The label-applying device 100 comprises a remote labelling control system (see for example 108 of FIG. 2) comprising a microcomputer (see for example 108a of FIG. 2) and a controller (Programmable Logic Controller; see for example 108b of FIG. 2) interconnected through a line (see for example 117 of FIG. 2). An electrical cable 107 (FIG. 1) interconnects the remote labeling control system 108 to the rest of the label-applying device 100.

Turning now to the non-limitative example of FIG. 2:

The in-line egg-labelling system comprises a first label-applying device 100a comprising an internal controller 113a connected to the controller 108b through an electrical cable 107a, and a second label-applying device 100b comprising an internal controller 113b connected to the controller 108b through an electrical cable 107b. For example, the first label-applying device 100a can be installed, as mentioned in the foregoing description, between the second and third egg-packing stations. The second label-applying device 100b can be installed, for example, between the third and fourth egg-packing stations or besides the first label-applying device 100a to apply labels on the eggs being carried by a second parallel series of egg grippers projecting downwardly from the chain conveyer 201.

The label-applying devices 100a and 100b comprise a common remote labelling control system 108 comprising the microcomputer 108a and the interface module 108b interconnected through a line 117.

The labelling control system 108 comprises a proximity sensor 112 upstream the label-applying device 100a and 100b, and connected to the controller 108b through a line 116. The proximity sensor 112 is used to detect the egg grippers 205 to allow the controller 108b to evaluate the linear speed of the chain conveyer 201 in real time (based on the strobe frequency and the known pitch of the grippers 205 on the conveyer 201) and the position of the eggs 206 to be printed.

The egg sorting and packing system 200 comprises an egg-packing controller 207 connected to the controller 108b through data lines 114 and 115, and to a pair of ink jet printers 208 and 209 installed, as indicated in the foregoing description, between the first egg-processing station and the second egg-packing station.

A first air blower 109a, associated to the label-applying device 100a is connected to the interface module 108b through a line 119. A second air blower 109b, associated to the label-applying device 100b is connected to the interface module 108b through a line 118.

The proximity sensor 112 is used to detect the incoming egg grippers 205. This proximity sensor 112 produces an output signal supplied to the controller 108b through the line 116, and used by the labelling control system 108 to calculate a current speed of the chain conveyer 201 (based on a strobe frequency and a known pitch of the egg grippers 205 of the chain conveyer 201) and to determine the position of the next egg 206 to be labelled. This information is used by the labelling control system 108 to determine when a signal should be sent to the label-applying devices 100a and 100b to present a label to the incoming egg 206 and at what speed the label shall be advanced to match the speed of this incoming egg. In this manner, the label 106 is applied to the lower surface of the egg 206 with negligible differential speed between the egg and the label and, consequently, no significant force has to be exerted by the egg to pull the label. Adhesion can thus be reliably performed with no slipping or dragging and the label be accurately positioned on the lower surface of the egg. In an exemplary simplified form, the output of the proximity sensor 112 is directly connected to the internal controllers 113aand 113b of the label-applying devices 100a and 100b and the sensor 112 is positioned so that the time delay required by the egg to move from that position matches the time response delay (natural inherent time delay or implemented adjustable time delay) of the label-applying devices 100a and 100b .

Still referring to FIG. 2, the data lines 210 and 211 allow communication between the egg-packing controller 207 and the two ink jet printers 208 and 209, as provided for example in typical egg grading and packing systems such as the one manufactured and commercialized by the company Diamond Systems. The data communicated from the egg-packing controller 207 to the ink jet printers 208 and 209 indicate the destination station of each egg 206 and whether this egg should be printed or not.

Data input lines 114 and 115 of the controller 108b of the labelling control system 108 are connected to the data lines 210 and 211 to pick-up the data communicated from the egg-packing controller 207. These data are interpreted by controller 108b to determine the destination station of each egg 206. The information about the destination of the eggs 206 is used by the controller 108b to determine whether a given egg must be labelled or not according to instructions from the microcomputer 108a. Corresponding control signals are produced and supplied by the controller 108b to the internal controllers 113a and 113b through the cables 107a and 107b, respectively, to control labelling of the eggs 206.

The computer 108a is also used by the operator to enter the destinations for which eggs are to be labelled and the desired number of eggs to be labelled, for example the number of eggs to be labelled by dozen package under the form of a ratio (ex. 1/1, 1/2, 1/3, 1/4, 1/6, 1/12). This information is used by the controller 108b to determine what eggs will be labelled. Corresponding signals are transmitted to internal controllers 113a and 113b to trigger label ejection from the label-applying devices 100a and 100b according to the position of the egg and the delay of reaction of the label-applying devices.

The air blowers 109a and 109b, connected to the labelling control system 108 through lines 118 and 119, respectively, are powered by the controller 108b when the corresponding label-applying devices 100a and 100b are operating.

In operation, all the eggs 206 supported in the series of egg-retaining grippers 205 of the chain conveyer 201 follow a linear path and eventually contact the smoothing brush 105 of a corresponding label-applying device 100a, 100b. When the controller 108b determines that an egg is to be labelled, upon sensing the presence of the corresponding egg gripper 205 through the proximity sensor 112, the label-applying device 100a, 100b is triggered to feed a label at proper speed and time, so that the egg gently catches the label on its path before hitting the brush 105 which conforms itself to the shape of the egg and applies some pressure on the label to secure it to the egg surface. It shall be noted that the only movement performed by the label-applying device 100a, 100b is to move the paper backing ribbon to peel-off and expose a label 106 at the proper time and speed. Eggs of different sizes, from medium to extra-large, are properly handled by the system since the label 106 hits the egg surface earlier on a larger egg, which only slightly changes the position of the label along the longitudinal axis of the egg 206. Also, thin plastic labels such as 106 of a thickness of the order of 0.002 inch are used to facilitate conformance of the label to the shape of the egg surface and prevent formation of ridges, to thereby provide a uniform surface and neat presentation.

Referring to FIG. 2, it should be mentioned that the non-restrictive illustrative embodiment of the in-line egg-labelling method and device of the present invention may operate as described herein above with a single label-applying device 100 as illustrated in FIG. 1, a single internal controller 113, a single proximity sensor 112, a single blower 119 and a single ink jet printer 208 or 209. The non-restrictive illustrative embodiment of the in-line egg-labelling method and device of the present invention may also operate as described herein above with more than two label-applying devices, more than two internal controllers, more than two proximity sensors, more than two blowers and more than two ink jet printers.

Those of ordinary skill in the art will easily appreciate that the above-described illustrative embodiment of the present invention provides an effective solution to the labelling of eggs on a grading and packing line. It can also be seen that the in-line egg-labelling method and system according to the present invention provide improved features with unmatched economic and functional performance and numerous advantages over the solutions of the prior art.

Non restrictive illustrative embodiments of an advertising media and a managing method and system according to the present invention for use with the above described in-line egg-labelling method and system will now be described in connection with the appended drawings. In the following description, the term “advertising” shall be deemed to generally include communication by a first party (advertiser) of any information (message) to be perceived and decoded by a plurality of second parties (consumers).

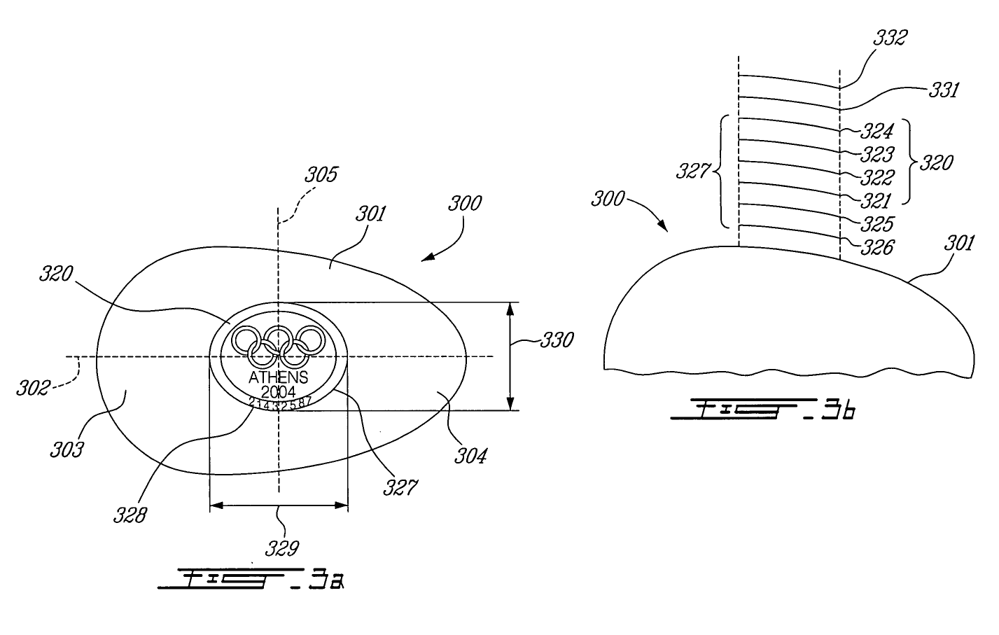

Referring to FIG. 3a, there is illustrated an advertising media generally identified by numeral 300, comprising an eggshell 301 on which an indicia 320 is applied. The eggshell 301 defines a longitudinal axis 302 connecting the two ends 303 and 304 of the eggshell, and a central plane 305 intersecting the axis 302 at right angle and halfway between the two ends 303 and 304 of the eggshell 301. Indicia 320 is representative of information (message) to be communicated to a consumer experiencing visual contact with the eggshell 301 and the indicia 320. For good visual and cognitive impact in communicating the information, the indicia 320 preferably comprises at least two colours. The indicia 320 is also preferably located on a peripheral, lateral area of the eggshell 301, and therefore extends between the ends 303 and 304, substantially in the direction of the axis 302 and intersects the central plane 305.

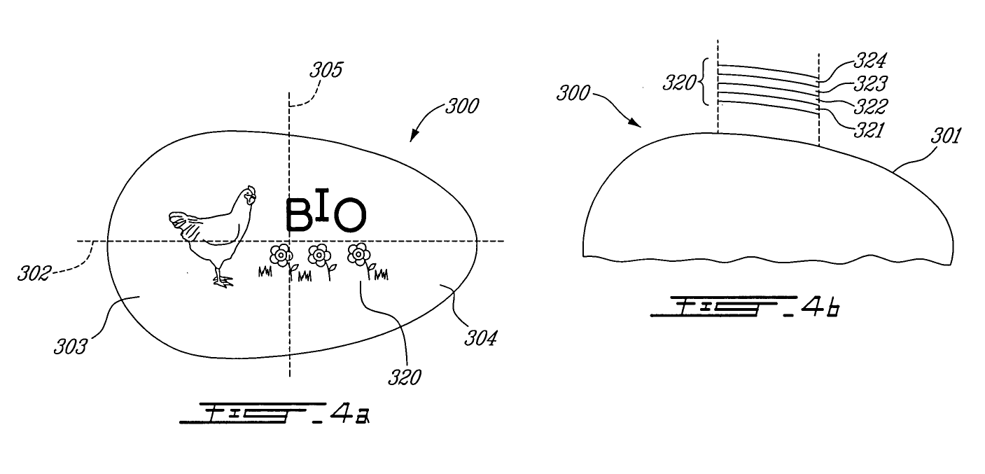

In the example of FIGS. 3a and 4a, the indicia 320 is substantially centered about the central plane 305 of the eggshell 301. This location generally provides the largest area of exposure with acceptable curvature of the surface. Therefore, the largest indicia can be received in this area to obtain the highest visibility for most indicia application technologies. Nevertheless, small highly visible colour indicia can be applied to the end areas 303 and 304 of the eggshell 301 for specific advertising purposes. Still in the example illustrated in FIG. 3a, wherein indicia 320 comprises the emblem of the 2004 Olympic games, at least five colours shall be visually perceived to provide an appropriate representation.

As better shown in FIG. 3b, for optimal quality, impact and convenience, multi-colour indicia 320 can be obtained by printing four screened half-tone monochrome images 321, 322, 323 and 324 on a substrate 325 provided with a pressure sensitive adhesive layer 326 to form an indicia bearing adhesive label 327. Label 327 is thereafter applied to the surface of the eggshell 301, using the in-line egg-labelling method and system as described in the foregoing description. The label 327 is preferably provided with a long axis 329 and a short axis 330, the long axis 329 extending substantially parallel to the longitudinal axis 302.

The colours of the four monochrome images 321, 322, 323 and 324 composing indicia 320 are preferably yellow, cyan, magenta and black and these images are applied to the substrate 325 in registered superposition by successive printing steps according to common techniques known to those of ordinary skill in the art. It should also be mentioned that multi-colour indicia of high visual impact can also be obtained by superposing solid colour images, each representing a part of indicia 320, or by using a printing system with more than four process colours.

Moreover, although application of pre-printed labels can be used for transferring the indicia 320 to the eggshell 301, direct (one-step) transfer of the superposed monochrome images 321, 322, 323 and 324 can be contemplated, as illustrated in FIGS. 4a and 4b. According to a printing process known to those of ordinary skill in the art, monochrome images can be first successively applied in superposition on a blanket and then transferred from the blanket directly to the surface of the eggshell 301.

Referring back to FIG. 3a, indicia 320 may further comprise a sequence of alphanumeric characters 328. Such a sequence of characters may be serially, randomly or otherwise generated so to be variable for an advertising media 300 to another. Games or contests can also be implemented using the advertising media 300, in addition to providing means for communicating further variable type of information, such as a product number, bar code, etc. For games and contests, it is further contemplated that labels may incorporate a scratchable or peel-off cover layer (see for example 331 in FIG. 3b) that may also comprise a second printed indicia on the top thereof (see for example 332 in FIG. 3b).

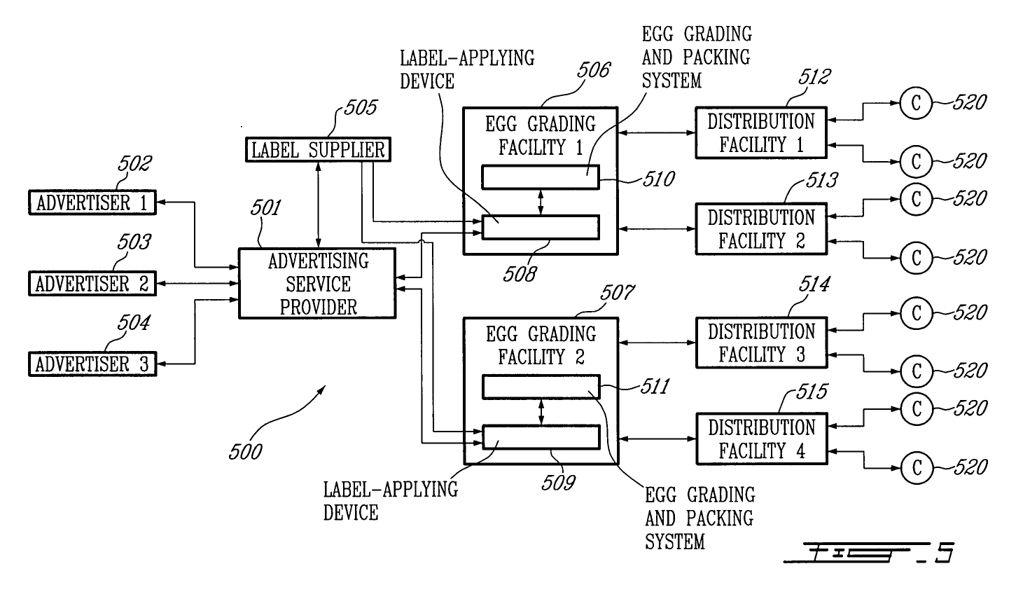

Turning now to FIG. 5, there is disclosed a system 500 for the management of advertising using the eggshells as a vehicle. The example of FIG. 5 refers to labelling of eggs as the advertising media. However, label supplies can be substituted by printing template supplies and the label-applying devices such as 508 and 509 can be substituted by a blanket transfer printing device.

The advertising management system 500 comprises an advertising service provider 501, at least one advertiser such as 502, 503 and 504, a label supplier 505 and at least one egg grading facility such as 506 and 507, each facility being provided with a label-applying device 508 or 509 such as the label-applying device 100 of FIG. 1, and an egg grading and packing system such as 510 and 511. In operation, the advertising service provider 501 obtains advertising parameters from at least one advertiser such as 502, 503 and 504, these advertising parameters generally comprising, for example:

information (message(s)) to be communicated to consumers 520;

a total number of eggs to convey the message(s);

a time period for diffusion of the message(s);

a number of message conveying eggs per dozen or pack (or percentage of coverage); and

targeted egg distribution facilities such as 512, 513, 514 and 515, for example specific grocery stores.

It should be pointed out that the information or message(s) may comprise a variable portion such as a serial number or a random sequence of characters (see 328 in FIG. 3a) that could be used for instance to select a winner in a contest. Such variable information may also be hidden under a scratchable or peel-off cover layer.

The advertising service provider 501 then obtains labels representative of the information or message(s) to be diffused from the label supplier 505, these labels being delivered directly to one or more of the egg grading facilities such as 506 and 507 for installation on a label-applying device such as 508 and 509. The label-applying devices such as 508 and 509 are typically operated by the personnel of the service provider 501 to ensure strict compliance with the conditions of the advertising agreement entered into with one of the advertiser such as 501, 502 and 503. Each label-applying device such as 508 and 509 is connected to a communication link (for example through the microcomputer 108a of FIG. 2 being provided with an Internet connection) whereby advertising information data pertinent to each advertising campaign is communicated to the label-applying devices from a server at the headquarter of the service provider 501. The communication link is also connected to the egg grading and packing systems such as 510 and 511 in order to gather real-time information related to the destination of the eggs carried past each label-applying device.

In this manner, the shells of the eggs are labelled according to parameters agreed upon between the service provider 501 and an advertiser such as 502, 503 and 504 for a given campaign, and packed and shipped to wholesalers or retailers such as 512, 513, 514 and 515, to eventually reach consumers 520 according to a conventional packing and distribution process. The information or message integrated to the indicia 320 (see FIGS. 3 and 4) printed on the label 327, or directly applied to the eggshells 301, is then communicated to the targeted consumers 320.

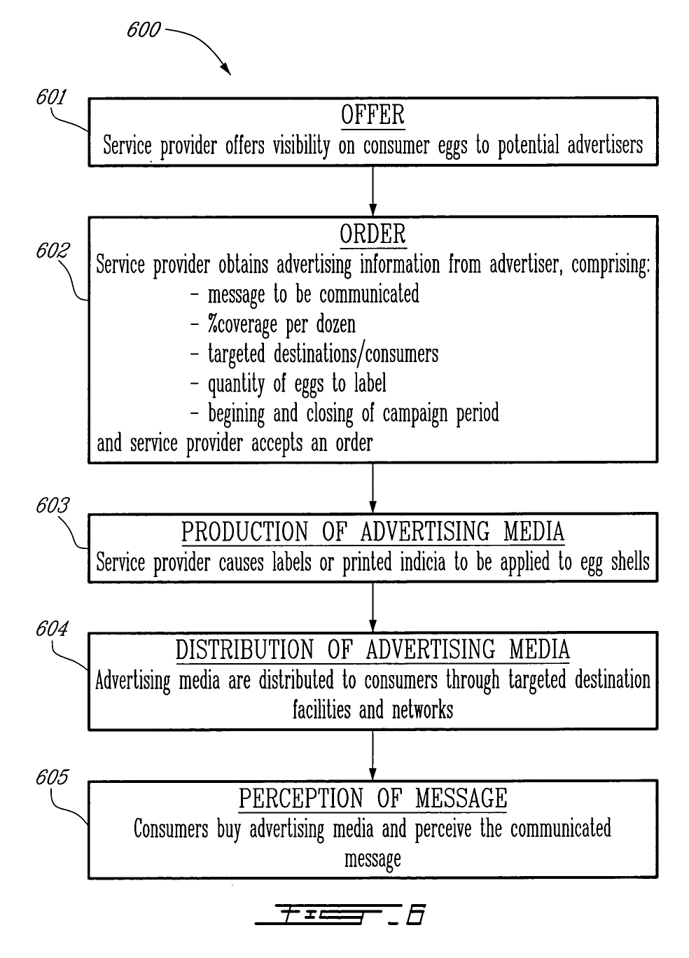

Turning now to the process chart of FIG. 6, a method 600 for the management of advertising using eggshells as a media will now be described.

The advertising management method 600 enables an advertiser to communicate information or a message to a plurality of consumers using eggshells as an advertising media or vehicle. The method comprises the following main steps:

Step 601: OFFER

This step is optional. An advertising service provider 501 offers visibility on the shells of consumer eggs to potential advertisers such as 502-504.

Step 602: ORDER

This step consists of obtaining advertising information from an advertiser such as 502-504, and accepting the order. The obtained parameters comprise at least:

a) informational data or message(s) to be communicated to consumers;

b) targeted destinations (geographical regions, distribution facilities/networks, and/or targeted group of consumers) for which eggs convey the message(s), and

c) a desired ratio for the number of message conveying eggs/number of packed eggs per destination;

d) a total number of eggs for conveying the message(s); and

e) a campaign time frame, i.e. beginning and closing dates defining time periods during which eggs are to be conveying the message(s).

Step 603: PRODUCTION OF ADVERTISING MEDIA

This step consists of obtaining printed labels representative of informational data (message(s)) and causing the labels to be adhesively applied to the shells of eggs destined to a distribution to a targeted group of consumers. The labels are preferably provided with multi-colour indicia, such as a four-color process images, representative of the message(s). Advantageously, the labels are applied to a lateral area of the eggshell surface, located between a first end and a second end of the eggshell, where minimal surface curvature is present for a given label area. The printed labels are preferably applied to the shells of the eggs in an egg grading facility, using an in-line egg-labelling system co-operating with a main sorting chain conveyer.

The advertising media may also be any indicia-bearing eggshell, such as a printed eggshell, or any message conveying means attached to an eggshell. Hence, obtaining labels may be replaced by obtaining printing templates representative of the indicia, and causing labels to be adhesively applied to eggshells may be replaced by printing a multi-colour indicia, representative of the informational data (message), on the shells of eggs destined to distribution to a number of consumers. In such a case, the multi-colour indicia is formed directly on the eggshell by individually printing successive monochrome image layers on a blanket and thereafter transferring the multi-layer multi-colour indicia from the blanket to the eggshell in a single step.

In an illustrative embodiment of the invention, step 603 comprises operating the egg-labelling system based on two following user set parameters:

a) the destinations for which eggs are to be labelled (packaging lines corresponding to targeted grocery stores, or distributors); and

b) the desired ratio for the number of labelled eggs/number of packaged eggs per destination.

Using more than one label-applying device may also provide for the capacity of selecting a message amongst a plurality of possible messages to be applied to a given egg.

These parameters are based on advertising information provided by the advertiser to the advertising service provider who communicates, for example by electronic communication, these parameters to the label-applying device controller and attendant (usually remotely located). In addition, step 603 comprises managing advertising media production data to ascertain that each order is properly completed. Production data and statistics are generated by the label-applying device controller and can be consulted on site by the attendant or remotely accessible to the advertising service provider or by the advertiser, through an electronic data communication link such as the intranet or internet.

Step 604: DISTRIBUTION OF ADVERTISING MEDIA

This step comprises sorting, packaging and delivering advertising media to distribution facilities and networks such as 512-515 corresponding to targeted destinations, in a conventional manner, so as to make the advertising media accessible to consumers.

Step 605: PERCEPTION OF MESSAGE

Consumers buy and handle advertising media and perceive the communicated message.

One can easily appreciate that the above described illustrative embodiments of the present invention provide an effective solution for the communication by a first party (advertiser) of any visual information (message) to be perceived and decoded by a plurality of second parties (consumers), using eggs as an advertising media or vehicle. And this effective solution presents numerous advantages over the solutions of the prior art.

Although the present invention has been described hereinabove by way of a non-restrictive illustrative embodiment thereof, this embodiment can be modified at will, within the scope of the appended claims, without departing from the spirit and scope of the present invention.

What is claimed is:

1. An advertising management method using eggs as advertising media to communicate at least one information/message from an advertiser to a number of consumers, comprising:
obtaining at least one information/message to be communicated from the advertiser;
obtaining from the advertiser parameters related to at least one targeted destination toward which eggs conveying the at least one information/message have to be directed, and a ratio of the number of information/message conveying eggs with respect to the total number of eggs directed toward the at least one targeted destination;
applying the at least one information/message to shells of the eggs directed toward the at least one targeted destination in accordance with the said ratio.

2. An advertising management method as defined in claim 1, wherein:
obtaining parameters also comprises obtaining from the advertiser a total number of information/message conveying eggs; and
applying the at least one information/message to eggshells comprises applying the at least one information/message to the shells of eggs directed toward the at least one targeted destination in accordance with said ratio until the total number of information/message conveying eggs has been reached.

3. An advertising management method as defined in claim 1, wherein obtaining parameters comprises:
obtaining from the advertiser a time frame during which the at least one information/message conveying eggs have to be distributed; and
applying the at least one information/message to eggshells comprises applying the at least one information/message to shells of the eggs directed toward the targeted destination in accordance with said ratio during the time frame.

4. An advertising management method as defined in claim 1, wherein:
obtaining parameters also comprises obtaining from the advertiser a total number of information/message conveying eggs and a time frame during which the information/message conveying eggs have to be distributed; and
applying the at least one information/message to eggshells comprises applying the at least one information/message during the time frame to shells of the eggs directed toward the at least one targeted destination in accordance with said ratio until the total number of information/message conveying eggs has been reached.

5. An advertising management method as defined in claim 1, wherein:
the parameter related to the at least one targeted destination is selected from the group consisting of: a geographical region, distribution facilities/networks, and a targeted group of consumers.

6. An advertising management method as defined in claim 1, wherein applying the at least one information/message to eggshells comprises:
obtaining printed self-adhesive labels bearing the at least one information/message to be communicated; and
selectively applying the self-adhesive labels to shells of eggs directed toward the at least one targeted destination.

7. An advertising management method as defined in claim 1, further comprising:
offering from an advertising service provider visibility on consumer-distributed eggs to potential advertisers.

8. An advertising management method as defined in claim 1, wherein applying the at least one information/message to eggshells comprises:
applying the at least one information/message to eggshells in an egg grading facility using an in-line egg-labelling system co-operating with a main sorting and packing chain conveyer.

9. An advertising management method as defined in claim 1, wherein applying the at least one information/message to eggshells comprises:
obtaining printing templates representative of the at least one information/message to be communicated; and
printing a multi-colour indicia representative of the at least one information/message to be communicated to eggshells.

10. An advertising management method as defined in claim 1, wherein applying the at least one information/message to eggshells comprises:
applying the parameters to at least one information/message applying device;
remotely managing the application of the at least one information/message on eggshells in order to ascertain that an order from the advertiser is properly performed.

11. An advertising management method as defined in claim 1, wherein each eggshell defines a longitudinal axis, a lateral area, and first and second opposite ends, and applying the at least one information/message to eggshells comprises:
applying the at least one information/message to the lateral area of eggshells, said information/message extending in the direction of the longitudinal axis between the first and second opposite ends.

12. An advertising management method as defined in claim 1, wherein applying the at least one information/message to eggshells comprises:
applying to eggshells an indicia representative of the at least one information/message to be communicated to a consumer experiencing visual contact with the eggs and the indicia.

13. An advertising management method as defined in claim 12, wherein:
the indicia comprises at least two colours for good visual and cognitive impact in communicating the at least one information/message.

14. An advertising management method as defined in claim 1, wherein applying the at least one information/message to eggshells comprises:
applying to eggshells a self-adhesive label bearing the at least one information/message to be communicated, the self-adhesive label having a long axis and a short axis, the long axis extending substantially parallel to the longitudinal axis of the eggshells.

15. An advertising management system using eggs as advertising media to communicate at least one information/message from an advertiser to a number of consumers, comprising:
an advertising service provider for obtaining form the advertiser:
the at least one information/message to be communicated to the number of consumers;
parameters related to at least one targeted destination toward which eggs conveying the information/message have to be directed, and a ratio of the number of information/message conveying eggs with respect to the total number of eggs directed toward the at least one targeted destination;
an information/message applying device applying the at least one information/message to be communicated to shells of the eggs directed toward the at least one targeted destination in accordance with the said ratio.

16. An advertising management system as defined in claim 15, wherein:
the advertising service provider also obtains from the advertiser a parameter related to a total number of information/message conveying eggs; and
the information/message applying device applies the at least one information/message to the shells of eggs directed toward the at least one targeted destination in accordance with said ratio until the total number of information/message conveying eggs has been reached.

17. An advertising management system as defined in claim 15, wherein:
the advertising service provider obtains from the advertiser a parameter related to the time frame during which the at least one information/message conveying eggs have to be distributed; and
the at least one information/message applying device applies the information/message to shells of the eggs directed toward the at least one targeted destination in accordance with said ratio during the time frame.

18. An advertising management system as defined in claim 15, wherein:
the advertising service provider obtains other parameters related to a total number of information/message conveying eggs and a time frame during which the at least one information/message conveying eggs have to be distributed; and
the information/message applying device applies the at least one information/message during the time frame to shells of the eggs directed toward the at least one targeted destination in accordance with said ratio until the total number of information/message conveying eggs has been reached.

19. An advertising management system as defined in claim 15, wherein:
the parameter related to the at least one targeted destination is selected from the group consisting of: a geographical region, distribution facilities/networks, and a targeted group of consumers.

20. An advertising management system as defined in claim 15, wherein:
the advertising management system further comprises a label supplier for supplying self-adhesive labels bearing the information/message to be communicated; and
the information/message applying device comprises a label-applying device, installed in an egg grading facility, for selectively applying the self-adhesive labels to shells of eggs directed toward the at least one targeted destination.

21. An advertising management system as defined in claim 15, wherein:
the advertising service provider offers visibility on consumer-distributed eggs to potential advertisers.

22. An advertising management system as defined in claim 15, comprising:
an egg grading facility using an in-line egg-labelling system comprising said information/message applying device and co-operating with a main sorting and packing chain conveyer for applying the at least one information/message to eggshells.

23. An advertising management system as defined in claim 15, wherein the information/message applying device comprises:
printing templates representative of the at least one information/message to be communicated, for printing a multi-colour indicia representative of the at least one information/message to be communicated on eggshells.

24. An advertising management system as defined in claim 15, wherein the advertising service provider comprises a communication link connected to the information/message applying device for remotely managing the application of the at least one information/message on eggshells in order to ascertain that an order from the advertiser is properly performed.

25. An advertising management system as defined in claim 15, wherein each eggshell defines a longitudinal axis, a lateral area, and first and second opposite ends, and the information/message applying device comprises:
an applicator of the at least one information/message to the lateral area of eggshells, said at least one information/message extending in the direction of the longitudinal axis between the first and second opposite ends.

26. An advertising management system as defined in claim 15, wherein the information/message applying device comprises:
an applicator of an indicia representative of the at least one information/message to be communicated to a consumer experiencing visual contact with the eggs and the indicia.

27. An advertising management system as defined in claim 26, wherein:
the indicia comprises at least two colours for good visual and cognitive impact in communicating the at least one information/message.

28. An advertising management system as defined in claim 15, wherein the at least one information/message applying device comprises:
a label-applying device which, in operation, applies to eggshells a self-adhesive label bearing the at least one information/message to be communicated, the self-adhesive label having a long axis and a short axis, the long axis extending substantially parallel to the longitudinal axis of the eggshells.

29. An advertising management system as defined in claim 15, wherein the at least one information/message comprises a variable portion selected from the group of a serial number and a random sequence of characters.

30. An advertising management system as defined in claim 22, further comprising a data communication link between the egg grading facility and the in-line egg-labelling system whereby data indicative of egg destination is communicated to the in-line egg-labelling system.

31. An advertising management system as defined in claim 29, wherein said variable portion is hidden by a removable cover layer.
